(19) United States
(12) Patent Application Publication
(10) Pub. No.: US 2024/0010138 A1
(43) Pub. Date: Jan. 11, 2024

(54) Functional Component for a Vehicle

(71) Applicant: Bayerische Motoren Werke Aktiengesellschaft, Muenchen (DE)

(72) Inventors: Stefanus BOSCH, Holzkirchen (DE); Martin FRIEDRICH, Muenchen (DE); Johannes KOLB, Eitting (DE)

(21) Appl. No.: 18/037,799

(22) PCT Filed: Oct. 28, 2021
(86) PCT No.: PCT/EP2021/079908

§ 371 Date: May 19, 2023

(30) Foreign Application Priority Data
Nov. 20, 2020 (DE) 10 2020 130 688.1

(51) Int. Cl. B60R 13/02; B60H 1/34; B62D 1/06

(52) U.S. Cl. CPC B60R 13/02; B60H 1/34; B62D 1/06; B60R 2013/0287

(57) ABSTRACT

A functional component for a vehicle is formed from at least one temperature-sensitive material and/or has at least one temperature-sensitive material, which is designed in such a way that, at at least a predefined limit temperature, an optically perceptible property for representing a temperature information, which describes the temperature of at least a part of the functional component, can be modified.

### BACKGROUND AND SUMMARY

The invention relates to a functional component for a vehicle. It is known that functional components can perform different functions within a vehicle. For example, a functional component can be in the form of a crash component so that it can selectively absorb deformation energy.

An object of the invention is to provide a functional component for a vehicle which outputs an information item or a temperature information item to a person in a simple and cost-effective manner.

The object is achieved by a functional component according to the independent claims. The claims which are dependent thereon relate to possible embodiments of the functional component.

The notion of the invention relates to at least a portion of a functional component which is formed from at least one temperature-sensitive material and/or comprises at least one temperature-sensitive material which is constructed in such a manner that, for at least one predefined limit temperature, an optically perceptible property can be changed in order to display a temperature information item which describes the temperature of at least a portion of the functional component. In that at least a portion of the functional component is subjected to an optically perceptible change in accordance with the temperature thereof, an observer can already be informed about the temperature thereof by inspecting or observing this functional component. This temperature information item can constitute a decorative information item or a signal information item which, for example, expressly cannot constitute a warning character with respect to a region, which is too hot to touch, of the functional component. In other words, as a result of the temperature control carried out for signaling purposes, in particular by heating, of the functional component which is described herein, a temperature information item can be output in a visually perceptible manner for a person, wherein this temperature information item comprises an information acquisition, which does not relate primarily to the temperature per se, for the person, but instead a different information item is displayed to the person indirectly via the change of the optical property of the material of the functional component.

For example, an information item which indicates an operating state of a vehicle parameter is hereby output. The operating state of the vehicle parameter may comprise, for example, a parameter which depicts a driving property of the vehicle and/or a parameter which relates to an entertainment system of the vehicle. Generally, any information items can be visually output to a person via the functional component if he/she carries out a correspondingly controlled, selective temperature control of the functional component via a temperature control device which is actively connected in thermal terms to the functional component. The functional component can be arranged or constructed in a vehicle interior and/or at an outer side of the vehicle in order to output a visually perceptible signal to a person who is located inside the vehicle or outside the vehicle.

The optically perceptible change of the functional component is carried out in the event of a predefined limit temperature being exceeded or not being reached. The predefined limit temperature is orientated toward the temperature ranges which are orientated within the correct use of the functional component by accordingly selecting a suitable material and/or the arrangement thereof within the functional component. That is to say, for example, that in accordance with the usual temperatures of the functional component, during the correct use thereof a where applicable slight thermal change is brought about so that a selective optical change is carried out. Alternatively or additionally, the predefined limit temperature and/or the temperature control device can be configured in order to selectively control the temperature of the functional component so that by controlling the temperature control device a selective temperature control of the functional component can be carried out at least mainly, preferably exclusively, with a selective optical change of the functional component. For example, the predefined limit temperature at which a change of the optically perceptible property is carried out is in the range from −30° C. to 80° C., preferably in the range from −10° C. to 60° C., particularly preferably in the range from −5° C. to 40° C.

The material, which changes its optical property depending on the temperature, of the functional component can also be referred to as a thermochromic material. This material may, for example, be in the form of a coating and/or a component, which is particularly present in a homogeneous manner, of the material which forms the functional component. The material may also have a luminescence or comprise components which have a luminescent property. This can be carried out, for example, by carrying out an infiltration of the material which forms the functional component with a thermoluminescent filler material. A dyeing of the material, which forms the functional component, can also be carried out under pressure, for example, a coating, particularly a full coating.

The perceptibility of the optical change can be facilitated for the user in that adjacent regions of the functional component and/or adjacent functional components which adjoin the functional component have no change or have a different change of the optically perceptible properties thereof (optical property changes having other limit temperatures and/or other types of optically perceptible property change). The information item, in particular the temperature information, can display a defined first information item to a person using the display of a predefined temperature limit value being exceeded or not reached, for example, in the case of being exceeded. In the case of a value not being reached, a defined additional information item which is different from the first information item can be output for the operator.

In a preferred embodiment, there is provision for at least a first region of the functional component to be formed from a first temperature-sensitive material and/or to comprise at least a first temperature-sensitive material with a first predefined limit temperature and at least a second region of the functional component to include a second temperature-sensitive material and/or to comprise a second temperature-sensitive material which is constructed in such a manner that an optically perceptible property is or can be changed at least at one predefined second limit temperature which is different from the first limit temperature. In that the two materials and therefore the respective regions of the functional component at different limit temperatures are subjected to an optically perceptible property change, a differentiated temperature information item or different predefined information items can be output for the observer. Thus, the observer can be shown, if the optical change of only one temperature-sensitive material is perceived, that a first temperature threshold value has been exceeded and/or not reached. If the second temperature-sensitive region and therefore the second limit temperature has further been exceeded and/or not reached, the observer is shown, by displaying the change of the optical properties of both regions, that a higher temperature (in the case of the respective limit temperature being exceeded) is present because both limit temperature values have been exceeded. As a result, for example, the observer can carry out a differentiated selection for handling instructions and/or can visually receive information items which are occupied with thematically different aspects. In this instance, a, particularly electrically, controllable temperature control device can be controllable in such a manner that selectively different limit temperature values or different temperature ranges between at least two different limit temperature values can be thermally controlled. As a result, at least two, preferably at least three, extremely preferably at least four operating phases which lead to optically differently perceptible states can be selectively controlled via the temperature control device.

There may further be provision for at least one region of the functional component to comprise a non-temperature-sensitive material and/or to include a non-temperature-sensitive material, wherein the non-temperature-sensitive material is constructed in such a manner that no optically perceptible property changes with action of heat. In this case, a temperature range from −20° C. to 350° C., preferably from −5° C. to 100° C., particularly preferably a temperature range from 5° C. to 50° C. is again advantageous as an operating range for the optically perceptible property change which does not occur this time. Particularly when within the temperature ranges mentioned no optically perceptible property change of the region which has the non-temperature-sensitive material is present, a reliable, rapid and simply perceptible signaling of the temperature of at least a portion of the functional component can thereby be achieved because the contrast of the non-temperature-sensitive material with respect to the adjacent temperature-sensitive material allows easier perception.

Additionally or alternatively, there may be provision for a region of the functional component to comprise a material and/or to include a material, wherein the material has a higher thermal conduction coefficient than at least one temperature-sensitive material, preferably a higher thermal conduction coefficient than all the temperature-sensitive materials of the functional component. This region, which is provided with a higher thermal conduction coefficient, of the functional component can also be referred to as the thermal conduction region, the function of which is to ensure a reaction of the temperature-sensitive material of the functional component in a manner which is as rapid as possible even if the temperature-sensitive material of the functional component is arranged at a position which is remote from the causative heat source (for example, a selectively controllable temperature control device). The region, which is in the form of a thermal conduction region, of the functional component therefore preferably directly touches at least one temperature-sensitive material, preferably all the temperature-sensitive material of the functional component. It is also advantageous if the region, which is in the form of a thermal conduction region, is surrounded at least in regions by a thermal insulation region, that is to say, a region with a material, which has a thermal conduction coefficient which is as small as possible. A thermal conduction coefficient, which is as small as possible, of a region of the functional component can already be present if this region has a smaller thermal conduction coefficient than the remaining regions or at least one adjacent region of the functional component.

The optically perceptible property of the temperature-sensitive material may be changeable in a reversible or non-reversible manner, preferably the optically perceptible property of both a first temperature-sensitive material and a second temperature-sensitive material is constructed to be changeable either in a reversible or in a non-reversible manner. There may also be provision for a first temperature-sensitive material to be constructed in such a manner that the optically perceptible property thereof is constructed in a reversible manner and a second temperature-sensitive material is constructed in such a manner that the optically perceptible property is changeable in a non-reversible manner. A functional component which is provided with two different temperature-sensitive materials can therefore allow the observer to be given information simultaneously as to whether a predefined temperature limit value was ever exceeded (non-reversible material property) and at the same time whether currently a predefined temperature limit value is being exceeded, that is to say, for example, that the functional component currently has a specific or higher temperature. In the case of the non-reversible property change of the material, this information can be used so that it can be identified whether the functional component has already exceeded a limit temperature once before, which leads to at least one partial information item being displayed in an irreversible manner on the functional component.

The functional component may advantageously be produced at least partially from an additive production method. Particularly the at least one region, which includes a temperature-sensitive material, of the functional component can be produced from an additive production method. Alternatively, the entire functional component can be produced from an additive production method. It is also possible for the functional component to be produced at least partially from a forming or an initial forming method. It is thus possible for the functional component to be at least partially produced from an injection-molding method. In particular, at least one region, which includes a temperature-sensitive material, of the functional component can be at least partially, particularly completely, produced from an injection-molding method. Alternatively, the entire functional component can be produced from an injection-molding method.

There may be mentioned as advantageous, specific production methods for at least partially, in particular completely producing the functional component, for example: fused deposition modeling, stereolithography, selective laser melting, selective laser sintering, polyjet, multijet fusion, injection-molding, extrusion, calendering, foaming, injection blow-molding, metal casting or metal sintering. The multijet fusion method is a technology based on powder. The powder bed is uniformly heated and a heat-conducting fluid is injected if particles have to be selectively molten. Additionally, a heat-insulating fluid is injected around the contours for which a sharp edge is desired. PLA, ABS, thermoplasts, duroplasts, PA11, PA12, polypropylene and/or polyethylene can be used as plastics materials for the functional component. In a specific, exemplary embodiment, a PLA (polylactic acid) filament was used for an FDM (fused deposition modeling) printing method, wherein the optical property change included a color change from purple to pink. The printing temperature is preferably from 180° C. to 230° C. in this case and/or the printing bed temperature is preferably from 0° C. to 80° C. in this case and/or the printing speed is preferably from 40 mm/s to 110 mm/s in this case and/or the movement speed is preferably from 90 mm/s to 150 mm/s in this case.

In a preferred embodiment, the temperature-sensitive material can form a small volume proportion of the functional component, for example, the thermochromic material of the functional component can constitute a volume proportion less than 20%, preferably less than 10%. Alternatively, it can also be advantageous for at least 80% by volume of the functional component to be formed from the at least one temperature-sensitive material and/or to include the temperature-sensitive material, preferably at least 95% by volume or the entire functional component can also be completely formed from a temperature-sensitive material and/or can include the temperature-sensitive material. In this case, the functional component is simplified by the structure since no combination or connection and the technical production handling of second materials thereof have to be taken into consideration. The above-mentioned percentage indications preferably relate in this case to all the totaled volume values of all the temperature-sensitive materials of the functional component. The term “temperature-sensitive material” of the functional component is intended to be understood to mean materials which have an optically perceptible property change if at least one predefined limit temperature is exceeded.

The at least one thermochromic region of the functional component may be connected to the functional component in a non-releasable manner. This means a connection such that a release of this region is not provided for and can, for example, if at all, only be carried out with an intervention which destroys the functional component. Alternatively or additionally, the temperature-sensitive region of the functional component may be constructed integrally or in one piece with the functional component.

The term “region of the functional component” may be understood to be both an integral region, that is to say, a region which forms an integral component, and a region which forms a component, which is in the form of a separate element, of the functional component. In the case of the separate element, it can be positioned thereon and connected thereto as a constructed portion of a functional component. In other words, a so-called region of the functional component can be both a delimited, for example, inserted element, and a, for example, functional component region which is produced in situ with the functional component. In particular, the mentioned regions of at least one temperature-sensitive material and/or at least one non-temperature-sensitive material and/or at least one material which is provided with a higher thermal conduction coefficient are included by this definition of a region of the functional component.

The at least temporarily changeable, optically perceptible property of the at least one temperature-sensitive or thermochromic material can include the color and/or the degree of transparency and/or the degree of translucence and/or the surface sheen. In particular, by changing the color of the temperature-sensitive material, the observer of the functional component can readily perceive a temperature information item. The degree of image or viewing permeability (transparency) and/or the degree of light-permeability (translucence) can also, alternatively or additionally, positively influence the perception of the temperature information for the observer.

With regard to the field of application of the functional component, which includes a temperature-sensitive or thermochromic material, it could be found to be advantageous if the functional component is at least a portion of an input means of a vehicle. The term “input means” may be understood to be all means which record an acoustic signal (for example, microphone) and/or an optical signal (for example, camera) and/or a tactile signal (for example, button, switch, lever) of an operator. For example, a handle for adjusting the position and/or the orientation of an internal mirror and/or external mirror may be in the form of a functional component or include such a functional component. Generally, therefore, it is possible to make an optically perceptible information item visually perceptible directly at the input means for an operator. Particularly input means for recording tactile or optical signals are typically positioned relative to an operator so that these input means can also be readily seen by the operator so that an operator can readily identify an optical perceptible change of a functional component which is arranged at that location. This visual signal output is also intuitively readily perceptible for the operator and can be classified because for the particularly tactile signal input a focusing of the input means by the operator is already present during operation in many cases and therefore the attention of the operator is comfortably produced at the location of the optically perceptible signal output or property change of the functional component.

It is possible for the input means to be a gear selection element, in particular a gear selection lever. A gear selection element can also be positioned, for example, in such a manner that the surface thereof can readily be seen by a person who is operating the gear selection element during correct operation of a vehicle. Thus, it is possible for a temperature control device to be arranged or constructed in or on the gear selection element. This temperature control device can, for example, have, primarily, in particular exclusively, the function of a selective temperature control of the functional component and therefore of a selectively controlled, optically perceptible property change. As a result of a selective temperature control of the gear selection element, in particular of a gear selection lever, for example, a selective change of the color of at least one component of the gear selection lever can be carried out in order to output a decorative effect and/or in order to output a vehicle-specific information item to a vehicle occupant. Preferably, an information item specific to the gear selection lever operating type can thereby be displayed visually, for example, whether the vehicle is in an operating mode “neutral gear engaged” and/or “defined forward gear engaged” and/or “defined reverse gear engaged” and/or “sports drive mode active”.

The gear selection element which is in the form of a functional component and/or which includes a functional component can, for example, be arranged or constructed in the central console, that is to say, for example, between a driver and passenger seat and/or in an instrument panel, also called a dashboard, and/or on or in the region of a steering wheel. The gear selection element may, for example, be in the form of a button and/or switch and/or an actuating lever and/or a switching or pressing rocker switch.

It is possible for the input means to be a steering wheel and/or a steering member, in particular a handlebar grip. The steering wheel may be in the form of a steering wheel of a motor vehicle, for example, a passenger vehicle or a utility vehicle. The steering member may comprise, for example, a handlebar of a two-wheeled vehicle, in particular a motorcycle or a bicycle. A steering member may also form a control knob of a vehicle, for example, a joystick of an aircraft and/or a construction vehicle or a construction machine.

The temperature control of the functional component by means of a temperature control device can be carried out, for example, by a heating element for heating a steering wheel and/or a steering member. In other words, the temperature control device may perform a double function, according to which both (a) a temperature control of an input means for more comfortable use by an operator and (b1) a display of a temperature information item for displaying a temperature state of the heated input means and/or (b2) a different information item is or can be output by selectively controlled temperature control of the functional component for outputting an information item which does not relate to the temperature control of the functional component per se.

The functional component can form, for example, at least a portion of a supply device and/or directing device for supplying and/or directing air to an interior of a vehicle, in particular a motor vehicle. Such a supply device and/or directing device may include, for example, the interior ventilation of a vehicle. The supply device and/or directing device which is provided with a functional component which is described herein may, for example, include at least one, in particular all, outlet nozzle(s) of such an internal ventilation system of a vehicle. The supply device and/or directing device may, for example, include at least one outlet nozzle and/or at least one handle for changing the direction and/or the volume flow of air which is discharged from an outlet region. The outlet nozzle may, for example, include a flow directing element and/or a flow direction adjuster, preferably the region, which changes optically depending on temperature, of the functional component is in the form of a component of the flow directing element or a flow direction adjuster. In that the supply device and/or directing device typically allows temperature-controlled air to flow into a vehicle interior, for example, an optically perceptible change at the at least one outlet nozzle can be carried out in accordance with the temperature value of this air so that a vehicle occupant can “read” an optically perceptible information item which depends on the temperature of the introduced air at the at least one outlet nozzle.

In an advantageous optional development, there may be provision for (a) the supply device and/or directing device to have at least one outlet means which comprises a base member and a directing member which is movably supported relative to the base member, wherein (b) the directing member is provided with a directing portion, past or through which at least a portion of the air which is supplied and/or directed into the interior of the vehicle flows and (c) at least a portion of the directing member is constructed from or includes the material which changes its optically perceptible property in the case of a change in temperature. The base member may form, for example, a frame, on which, for example, the directing member is supported in a rotationally and/or longitudinally movable manner so that as a result of the change of the relative position and/or orientation of the base member relative to the directing member the air which is discharged from the at least one outlet means can be changed in terms of the volume flow and/or discharge direction thereof. For example, the directing member comprises directing elements which are grid-like or arranged or constructed in the manner of parallel lines.

In this case, it may be found to be advantageous for the directing member to comprise a channel-like, in particular channel-shaped, directing portion which is provided with an inlet region and an outlet region and through which at least a portion of the air which is supplied and/or directed via the outlet means into the interior of the vehicle flows, preferably a maximum of 50% by volume, particularly preferably a maximum of 25% by volume, extremely preferably a maximum of 10% by volume, of the air which is discharged via the outlet means into the interior is directed via the channel-like, in particular channel-shaped, directing portion. The directing portion can be, for example, in the form of a directing portion which is surrounded at least partially by a covering portion completely by wall portions which are formed by the directing member. In other words, at least a portion of the air which is introduced into the interior of the vehicle by the outlet means can be introduced via an inlet region, which is in the form of an inlet opening, into the channel-like, in particular channel-shaped, directing portion and can be discharged out of an outlet region, which is in the form of an outlet opening, from the channel-like, in particular channel-shaped, directing portion. It is possible for the channel-like, in particular channel-shaped, directing portion to have an at least partially non-constant cross section (for example, porous cross sectional portion) so that the air which is guided by the directing portion achieves a temperature control, which is as selective and rapid as possible, of the portion, which is subjected to an optically perceptible change in the event of a temperature change, of the functional component.

It is possible for the functional component to be constructed in such a manner that it has a small mass and at the same time a great surface at a contact region for a medium which acts on the functional component (for example, air supplied to the interior). For example, the functional component can be constructed at least partially, in particular completely, in a porous manner. An at least partially, in particular completely, porous construction type of the functional component also allows a medium which is guided on or through the functional component, in particular air, to lead as quickly as possible to a temperature control of the functional component by the medium or the air.

In an exemplary embodiment, there is provision for the functional component to be at least a portion of an exhaust gas device of a vehicle. For example, the functional component may be in the form of a portion of an insulation of an exhaust gas device or completely form the insulation.

The optical perceptibility of the functional component for an observer can be further advantageously influenced, for example, in that at least a first temperature-sensitive material with a first limit temperature for changing property optically (a) is surrounded by a non-temperature-sensitive material and/or (b) by at least one second temperature-sensitive material, which has a different second limit temperature with respect to the first temperature-sensitive material at least in regions so that at least after the first limit temperature is exceeded a pattern can be formed. Preferably, the pattern can be in the form of at least one alphanumerical character and/or at least one pictogram. In this case, it is advantageous if, after the first limit temperature has been exceeded, a substantial and therefore easily perceptible contrast between the first temperature-sensitive material and the non-temperature-sensitive material and/or the second temperature-sensitive material is produced. The pattern which is formed may include an alphanumerical character, such as, for example, letters, lettering, words, numbers or punctuation marks. In particular, the alternative or additional construction of the pattern as a pictogram can allow, independently of any language barriers, the observer of the functional component to detect a danger or, in general terms, a temperature information item which relates to the functional component.

In addition to the functional component for a vehicle, the invention also relates to an arrangement comprising a functional component which is described herein and a temperature control device, wherein thermal energy which is absorbed and/or discharged by the temperature control device acts on the functional component thermally. The temperature control device can be controlled, for example, exclusively or primarily for temperature control of the functional component for generating information in this case. That is to say, for example, that the control of the temperature control is carried out as a signal transmission for forming an optically perceptible signal at the functional component and in this case the actual temperature increase of the functional component is not what is involved, or something that is scarcely involved, but instead what is involved is a change of the optically perceptible properties of the functional component. For example, a temperature increase or heating of a functional component which is arranged or constructed in or on a vehicle interior can also be carried out in order to generate a selective optically perceptible information item at the functional component if a request to reduce the temperature of the vehicle interior is present.

In a preferred embodiment, there may be provision for, in the case of the control of a functional component for outputting an information item in a state controlled by a temperature control device, at the same time or in a temporally offset manner an air-conditioning device in the vehicle to carry out a compensation for thermal effects which run counter thereto where applicable by the temperature control device. In other words, there may be provision, if a request for cooling the interior is present and at the same time a heating, which counteracts this request, of the interior is brought about as a result of the functional component which is heated via the temperature control device in order to obtain a desired signal output by means of the functional component as a result of the thermochromic property thereof, for an air-conditioning device to be used, for example, in the form (a) of a vehicle air-conditioning system and/or (b) a seat heating unit and/or (c) a sliding roof and/or window control and/or (d) a fan setting in order to counteract the heating effect of the temperature control device, in particular the heating effect of the temperature control device is compensated for at least with regard for the influence thereof on the temperature of the vehicle interior.

A thermal energy which is absorbed by the temperature control device is intended to be understood in this case to mean a cooling of the functional component by the temperature control device by transmitting heat from the functional component to the temperature control device. A discharge of thermal energy is intended to be understood in this case to mean that the temperature control device heats the functional component.

The thermal energy which is absorbed or discharged by the temperature control device can be used at a rate of at least 25%, preferably at least 50%, particularly preferably at least 75%, extremely preferably at least 95%, to generate at least one descriptive temperature information item by exceeding and/or not reaching the predefined limit temperature. In other words, the temperature control device is mainly or virtually exclusively (except for an unintentional or unavoidable temperature control of adjacent components or the environment) used to selectively change the optically perceptible information item or temperature information item which is output via the functional component.

The invention further relates to a vehicle comprising at least one functional component which is described herein. For example, the functional component can be at least a portion of a supply device and/or directing device for supplying and/or directing air into an interior of a vehicle, in particular a motor vehicle, wherein the supply and/or directing of air into the interior has at least two outlet openings, wherein (a) at least a first outlet opening, in particular a first group of outlet openings, is/are in the form of a functional component with a property which changes the optically perceptible property thereof in accordance with temperature and (b) at least one additional outlet opening, in particular an additional group of outlet openings, which has no change or a different change which is dependent on the temperature of the optically perceptible property thereof, wherein (c) in at least one operating mode of the supply device and/or directing device mainly, preferably at a rate of at least 70%, particularly preferably at least 90%, extremely preferably at least 95%, the air which is supplied via the supply device and/or directing device into the interior is introduced via the first outlet opening, in particular via the first group of outlet openings. Therefore, it becomes possible to guide the air which is introduced into the vehicle interior selectively in at least one operating mode so that an information item which is as rapid and/or precise as possible about the current temperature of the air which is guided into the interior can be output via the functional component.

Optionally, a control of the air introduction of the vehicle could be configured in such a manner that, in the event that a temperature which is requested by a vehicle occupant for the air to be introduced does not correspond to the currently available air temperature, an air-conditioning device is operated in a first operating mode which guides air into the interior at a defined, in particular small, quantity, wherein, as a result of this air flow when a limit temperature is reached, a thermochromic property change at the correspondingly provided outlet means is achieved. As a result, an information item concerning the currently available air temperature of the air-conditioning device is available to the vehicle occupant as a result of the optical change of the functional component. The vehicle occupant can use this information item, for example, to reduce the desired temperature (intended temperature) if he/she is of the opinion that the currently available air temperature is already suitable for him/her.

Alternatively or additionally, the effect described in the preceding paragraph can be used in vehicles without any automatic air-conditioning unit or any air-conditioning system. If a minimum air stream is guided in or past the functional component at all times or at least in phases in order to be able to give the vehicle occupant an information item about the temperature, which is currently available via a vehicle heating system for temperature control of the vehicle interior, of air which can be blown into the interior.

Finally, the invention relates to a method for displaying a temperature information item of a functional component which is described herein.

All the advantages, details, configurations and/or features of the functional component according to the invention can be transferred or may be applied to the arrangement according to the invention, the vehicle according to the invention and the method according to the invention.

The invention is explained in greater detail with reference to an embodiment in the drawing of a functional component which is in the form of a vehicle functional component.

### BRIEF DESCRIPTION OF THE DRAWING

FIG. 1 is a schematic illustration of a functional component which is in the form of an outlet nozzle according to one embodiment.

### DETAILED DESCRIPTION OF THE DRAWING

The invention is explained in greater detail with reference to an air inlet nozzle of a vehicle. In this case, the invention is not limited to the application of a thermochromic material to air inlet nozzles, but instead can also be applied to other components.

At least a portion of the functional component 1 can be formed from at least one temperature-sensitive material 2 and/or include at least one temperature-sensitive material 2 and be constructed in such a manner that, at at least one predefined limit temperature, an optically perceptible property for a vehicle occupant 17 for displaying a temperature information item 3 which describes the temperature of at least a portion of the functional component 1 can be changed.

At least a first region 4 of the functional component 1 may, for example, be formed from a first temperature-sensitive material 2 and/or include at least a first temperature-sensitive material 2, wherein the temperature-sensitive material 2 has a first predefined limit temperature and at least a second region of the functional component 1 comprises a second temperature-sensitive material (not illustrated) and/or includes a second temperature-sensitive material 2 which is constructed in such a manner that, at at least one predefined second limit temperature, which is different from the first limit temperature, an optically perceptible property can be changed.

At least a region 4, which includes a temperature-sensitive material 2, of the functional component 1 may, for example, at least partially, in particular completely, be produced from an additive production method. Preferably, the entire functional component 1 is produced from an additive production method.

Alternatively or additionally, at least one region 4, which includes a temperature-sensitive material 2, of the functional component 1 may at least partially, in particular completely, be produced from an injection-molding method. In principle, it is possible for the entire functional component 1 to be produced from an injection-molding method.

The at least temporarily changeable property, which is optically perceptible for a vehicle occupant 17, of the at least one temperature-sensitive material 2 may, for example, include the color and/or the degree of transparency and/or the degree of translucence and/or the surface sheen.

The functional component 1 may, for example, be at least a portion of an input means of a vehicle. If an adjustment of the discharge direction of the air, which is discharged via the outlet nozzle, is carried out by directly touching the downstream region and therefore in the region of the first region 4, this region 4 can form an input means or a handle for adjusting the discharge direction.

It is possible for the input means to be a gear selection element (not illustrated), in particular a gear selection lever (not illustrated). Alternatively or additionally, the input means may be arranged or constructed in or on a steering wheel (not illustrated) and/or a steering member (not illustrated), in particular a handlebar grip (not illustrated).

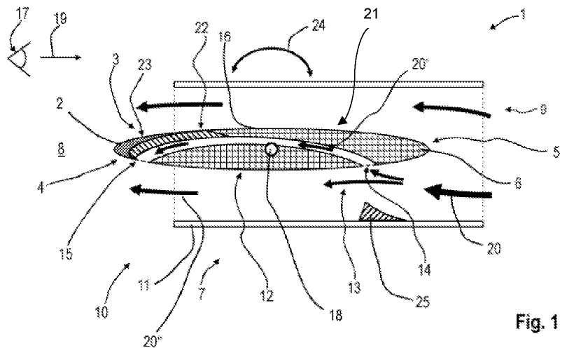

The functional component 1 may be, for example, at least a portion of a supply device and/or directing device for supplying and/or directing gas, in particular air 9, into an interior 8 of a vehicle, in particular a motor vehicle. FIG. 1 illustrates an air outlet nozzle and therefore a supply device and/or directing device 7 for supplying and/or directing gas, in particular air 9, into an interior 8 of a vehicle. In this case, the supply device and/or directing device 7 may comprise at least one outlet device 10 which comprises a base member 11 and a directing member 12 which is movably supported relative to the base member 11, wherein (a) the directing member 12 comprises a directing portion 13, past or through which at least a proportion of the air 9 which is supplied and/or directed into the interior 8 of the vehicle flows, and (b) at least a portion of the directing member 12 is constructed from the material 2 which changes its optically perceptible property in the case of a temperature change, or includes it. The base member 11 can be constructed in a channel-like manner, for example, the base member 11 is a retention frame, through which, on the one hand, the air 9 is guided and, on the other hand, the directing member 12 is movably supported, in particular pivotably via a pivot axis 18, cf. arrow 24.

The end, which is directed toward the interior 8, or the region, which is directed toward the interior 8, of the directing member 12 which is provided with the thermochromic material is in this case arranged or constructed in such a manner that the region is readily visible for a vehicle occupant 17 who is in the interior 8. The arrow 19 indicates the correct or typical viewing direction of a vehicle occupant 17 who is in the interior 8.

The directing member 12 may comprise, for example, at least one channel-like directing portion 16 which is provided with an inlet region 14 and an outlet region 15 and through which at least a portion of the air 9 which is supplied and/or directed via the outlet device 10 into the interior 8 of the vehicle flows, preferably a maximum of 50% by volume, particularly preferably a maximum of 25% by volume, extremely preferably a maximum of 10% by volume of the air 9 which is discharged into the interior 8 via the outlet device 10 is directed via the channel-like directing portion 16. The path of the gas or the air 9 which is guided via the outlet device 10 into the interior 8 is depicted by means of the arrows 20, 20′, A partial flow of the air 9 is guided along above the directing member 12 and reaches the interior 8 without any substantial redirection. A partial flow of the air 9 is guided under the directing member 12, cf. arrow 20. It is possible for at least one redirecting element 25 to be arranged or constructed on the directing member 12 and/or the base member 11. The redirecting element 25 can be configured to direct air 9 which flows past the directing member 12 to the inlet region 14. It thereby becomes possible for a relatively large amount of air 9 to be guided by the directing portion 16 even with a small volume flow of air 9 (cf. arrow 20′) in order to achieve a prompt or small latency when outputting the temperature information item 3 in the first region 4.

The air 9 which flows under the directing member 12, cf. arrow 20″, is combined, for example, with the air flow which is discharged from the outlet region 15 (cf. arrow 20′) and can be introduced into the interior 8 together.

There may be provision for the functional component 1 to have different portions 21, 22, 23 with different thermal conduction and/or thermal storage capacities. Thus, for example, a first portion 21, which is in particular spaced apart from the interior 8, of the directing member 12 may have a small thermal conduction and/or thermal storage capacity. This first portion 21 can preferably extend at least over at least the first third, preferably over at least the first half, particularly preferably over at least the first two-thirds, of the directing portion 13 when viewed in the flow direction. The directing portion 16 may be thermally connected at least partially, particularly completely, via a second portion 22, which has a higher thermal conduction capacity in comparison with the first portion 21, to a third portion 23 which comprises the thermochromic material. In other words, the second portion 22 may (a) directly adjoin or touch the, in particular channel-like, directing portion 16, and/or (b) directly adjoin or touch the third portion 23 which has the thermochromic material.

The portions 21, 22, 23 of the directing member 12 can, for example, have at least partially, in particular completely, an open or closed porous structure. In this case, a closed porous structure can allow a low degree of thermal absorption and/or discharge. An open structure can allow a high degree of thermal absorption and/or discharge as a result of the high surface which is effectively connected to the air 9.

The invention further comprises an arrangement comprising a functional component 1 which is described herein and a temperature control device, wherein thermal energy which is absorbed and/or discharged by the temperature control device acts thermally on the functional component 1 selectively. In the embodiment shown in FIG. 1, the temperature control device is substantially formed by the air 9 or the air flow. The fan device (not illustrated) and/or the air-conditioning device (not illustrated) and/or the pipework for the air flow may also be understood to be the temperature control device because these elements have a defined and/or selectively changeable influence on the temperature of the air flow or the air and consequently on the thermochromic material of the first region 4. The temperature control device may, alternatively or additionally, be a heating and/or cooling device which at least mainly has the function of heating and/or cooling the temperature-sensitive material 2. In other words, the temperature control device can be arranged or constructed in such a manner that the actual, in particular exclusive, function thereof is to achieve a corresponding, selective signal output which is visually detectable by changing the optically perceptible properties of the temperature-sensitive material 2 by selectively controlling the temperature control device.

The temperature-sensitive material 2 which can be changed by changing the optically perceptible properties thereof can, for example, at least partially, in particular completely, form the directing member 12 and/or the base member 11. Thus, it is possible for, for example, the peripheral region, which faces the interior 8, of the base member 11 a temperature information item 3 to be able to be visually output by a temperature-sensitive material 2 which is correspondingly arranged or constructed at that location.

The invention can further comprise, for example, a vehicle which is provided with a functional component 1 which is described herein. The functional component 1 can, for example, comprise at least a portion of a supply device and/or directing device 7 for supplying and/or directing air 9 into the interior 8 of a vehicle. The supply and/or direction of air 9 into the interior 8 can be carried out by means of at least two outlet openings, wherein (a) at least a first outlet opening, in particular a first group of outlet openings, is in the form of a functional component 1 with a property which changes its optically perceptible property depending on the temperature, and (b) at least one additional outlet opening, in particular an additional group of outlet openings, which does not have or has a different temperature-dependent change of an optically perceptible property as the first outlet opening. In at least one operating mode, the supply device and/or directing device 7 can, for example, mainly, preferably at a rate of at least 70% by volume, particularly preferably at least 90% by volume, extremely preferably at least 95% by volume, introduce into the interior 8 the air 9 which is supplied into the interior 8 via the supply device and/or directing device 7 via the first outlet opening, in particular via the first group of outlet openings.

The invention further relates to a method for displaying a temperature information item 3 of a functional component 1 which is described herein.

### LIST OF REFERENCE NUMERALS

1 Functional component
2 Temperature-sensitive material
3 Temperature information item
4 First region
5 Second region
6 Non-temperature-sensitive material
7 Supply device and/or directing device
8 Interior
9 Air
10 Outlet means
11 Base member of 10
12 Directing member of 10
13 Directing portion of 12
14 Inlet region
15 Outlet region
16 Directing portion
17 Vehicle occupant
18 Pivot axis
19 Arrow
20′, 20″ Arrow
21 First portion of 12
22 Second portion of 12
23 Third portion of 12
24 Arrow
25 Redirecting element

1.-15. (canceled)

16. A functional component for a vehicle, comprising:
at least one temperature-sensitive material forming and/or comprising at least a portion of the functional component,
wherein the temperature sensitive material is designed such that, at at least a predefined limit temperature, an optically perceptible property for representing a temperature information, which describes the temperature of at least a portion of the functional component, is changeable.

17. The functional component according to claim 16, wherein
at least a first region of the functional component is formed from the first temperature-sensitive material and/or comprises the first temperature-sensitive material,
the temperature-sensitive material comprises a first predefined limit temperature, and
at least a second region of the functional component includes a second temperature-sensitive material and/or comprises a second temperature-sensitive material which is constructed such that an optically perceptible property is changeable at least at one predefined second limit temperature which is different from the first predefined limit temperature.

18. The functional component according to claim 16, wherein
at least one region, which includes the temperature-sensitive material, of the functional component, is produced at least partially from an additive production method.

19. The functional component according to claim 16, wherein
at least one region, which includes the temperature-sensitive material, of the functional component, is at least partially produced from an injection-molding method.

20. The functional component according to claim 16, wherein
the changeable, optically perceptible property of the at least one temperature-sensitive material includes a color, a degree of transparency, a degree of translucence, and/or a surface sheen.

21. The functional component according to claim 16, wherein
the functional component is at least a portion of an input device of the vehicle.

22. The functional component according to claim 21, wherein
the input device is a gear selection lever.

23. The functional component according to claim 21, wherein
the input device is a steering wheel and/or a handlebar grip.

24. The functional component according to claim 16, wherein
the functional component is at least a portion of a supply device and/or directing device for supplying and/or steering air into an interior of the vehicle.

25. The functional component according to claim 24, wherein
the supply device and/or directing device comprises at least one outlet which comprises a base member and a directing member movably supported relative to the base member, and
the directing member comprises a directing portion, past or through which at least a portion of the air which is supplied and/or directed into the interior of the vehicle flows, and
at least a portion of the directing member is constructed from or includes the temperature sensitive material which changes its optically perceptible property in the case of a change in temperature.

26. The functional component according to claim 25, wherein
the directing member comprises a channel directing portion provided with an inlet region and an outlet region and through which flows at least a portion of the air which is supplied and/or directed via the outlet into the interior of the vehicle.

27. The functional component according to claim 26, wherein the portion of the air is one of:
a maximum of 50% by volume, a maximum of 25% by volume, or a maximum of 10% by volume.

28. An arrangement, comprising:
a functional component according to claim 16, and
a temperature control device, wherein thermal energy absorbed and/or discharged by the temperature control device acts on the functional component thermally.

29. A vehicle comprising at least one functional component according to claim 16.

30. The vehicle according to claim 29, wherein
the functional component is at least a portion of a supply device and/or directing device for supplying and/or directing air into an interior of a vehicle,
the supply and/or directing of air into the interior has at least two outlet openings,
at least a first outlet opening is in the form of a functional component with a property which changes the optically perceptible property thereof in accordance with temperature, and
at least one additional outlet opening has no change or a different change which is dependent on the temperature of an optically perceptible property thereof as the first outlet opening, wherein
in at least one operating mode of the supply device and/or directing device, at least 70% of the air which is supplied via the supply device and/or directing device into the interior is introduced into the interior via the first outlet opening.

31. The vehicle according to claim 30, wherein
the first outlet opening comprises a first group of outlet openings.

32. The vehicle according to claim 31, wherein
the second outlet opening comprises a second group of outlet openings.
